(19) United States
(12) Patent Application Publication
(10) Pub. No.: US 2026/0097982 A1
(43) Pub. Date: Apr. 9, 2026

(54) MOBILE WATER FILTERING SYSTEM

(71) Applicant: Freeway Systems LTD, Boulder, CO (US)

(72) Inventor: Patrick Amato, Boulder, CO (US)

(73) Assignee: Freeway Systems LTD, Boulder, CO (US)

(21) Appl. No.: 19/349,521

(22) Filed: Oct. 3, 2025

Related U.S. Application Data
(60) Provisional application No. 63/703,000, filed on Oct. 3, 2024.

(51) Int. Cl. C02F 9/20; B01D 61/02; B01D 61/04; B01D 61/08; C02F 1/00; C02F 1/28; C02F 1/44; C02F 1/461; C02F 1/467; C02F 1/68; C02F 101/12; C02F 101/20

(52) U.S. Cl. CPC C02F 9/20; B01D 61/025; B01D 61/04; B01D 61/081; B01D 2311/04; B01D 2313/24; B01D 2313/365; B01D 2313/367; C02F 1/002; C02F 1/283; C02F 1/441; C02F 1/46176; C02F 1/467; C02F 1/685; C02F 2101/12; C02F 2101/20; C02F 2201/005; C02F 2201/008; C02F 2201/009; C02F 2303/04

(57) ABSTRACT

Disclosed is a mobile water filtering system that is compact, lightweight, and capable of producing pure healthy water for numerous people in remote locations. In addition, the mobile water filtering system can include desalination so that ocean water can be purified to create drinking water. The system uses a low resistance sediment filter and a low resistance impurity filter prior to reverse osmosis filtration. Remineralization is provided of the filtered reverse osmosis water. A portable pump can be used together with a voltage regulator that allows application of a wide range of voltages from various voltage supplies.

### BACKGROUND OF THE INVENTION

Portable or mobile water filtration systems to provide potable water have been limited by the size and weight of the devices, the lack of aggregate filters and impurity filters that have high flow rates, the insufficient pressure from portable pumps necessary to perform reverse osmosis filtration, the lack of portable power supplies that have sufficient power to operate reverse osmosis filters after being pre-filtered, the lack of integrated storage for feed water, the inability of these systems to operate while being transported by an individual, the lack of readily available filter elements for operation of the system, and the lack of remineralization of filtered water for dietary and health reasons.

Further, there has been a proliferation of dangerous toxins in the water table as a result of chemical spills, combustion, groundwater leaching, and other processes, that pose a threat to the health of people throughout the world that rely on groundwater for drinking and cooking. In addition, there has been a reduction in the reliability of grid electricity and safe running water as a result of infrastructure degradation, natural disasters, regional conflicts, and other reasons.

### SUMMARY

The present invention may therefore comprise: a mobile system for filtering water to create potable water comprising: a feed bladder that is stored proximate to the mobile system, for storing unfiltered water from a water source to be filtered by the mobile system; a mobile pump that is self-priming and that can operate with battery power, the mobile pump configured to pump water from the water source for storage in the feed bladder, and pump water from the feed bladder to create a supply of unfiltered water that has a water pressure that is sufficient to pump the unfiltered water through at least two pre-filters and a reverse osmosis filtering system; an aggregate pre-filter that uses amino-silicate minerals to remove particles greater than five microns to create an aggregate reduced supply of pressurized water; a kinetic degradation pre-filter that removes chlorine, heavy metals and microorganisms from the aggregate reduced supply of pressurized water to produce an impurity reduced water supply; a reverse osmosis water filter that filters the impurity reduced water supply to produce a potable pressurized water supply; a re-mineralization canister that contains re-mineralization granules that creates potable, mineralized, pressurized water; a portable battery pack connected to the mobile pump and a voltage converter that allows charging by voltage sources that are less than and greater than an output voltage of the portable battery pack.

The present invention may further comprise: a method of filtering water to create potable water comprising the steps of: pumping unfiltered water, with a self-priming mobile pump that can operate with battery power, to a feed bladder for storage; pumping the unfiltered water from the feed bladder to create a supply of pressurized unfiltered water having a pressure that is sufficient to operate a reverse osmosis filtering system after passing through at least two pre-filters; applying the pressurized unfiltered water supply to an aggregate pre-filter that uses amino-silicate minerals that can pre-filter particles greater than five microns and create an aggregate reduced supply of pressurized water; applying the aggregate reduced supply of pressurized water to a kinetic degradation flexion pre-filter to remove chlorine, heavy metals and microorganisms to produce an impurity reduced pressurized water supply; applying the impurity reduced pressurized water supply to a reverse osmosis filter to produce a potable, pressurized water supply; applying the potable, pressurized water supply to a remineralization system to create potable, mineralized, pressurized water; using a battery pack to supply power to the self-priming, mobile pump, the battery pack configured to be changed from a solar collector; providing a secondary power input and a voltage regulator so that power sources that are greater than and less than voltage produced by the battery pack can be used to power the method of filtering water and to change the battery pack.

### BRIEF DESCRIPTION OF THE DRAWINGS

FIGS. 1A and 1B are schematic block diagrams of an embodiment of the present invention illustrating the various components of the mobile water filtering system.

FIG. 2 is a schematic diagram illustrating and embodiment of a form factor of the portable water filtration system, illustrating the components of the system.

FIG. 3 is an isometric view of the mobile water filtering system.

FIG. 4 is a top view of the mobile water filtering system.

FIG. 5 is an end view of the mobile water filtering system.

FIG. 6 is an opposite end view of the mobile water filtering system.

FIG. 7 is a side view of the mobile water filtering system.

FIG. 8 is an opposite side view of FIG. 7.

FIG. 9 is a bottom view of the mobile water filtering system.

### DETAILED DESCRIPTION OF THE EMBODIMENTS

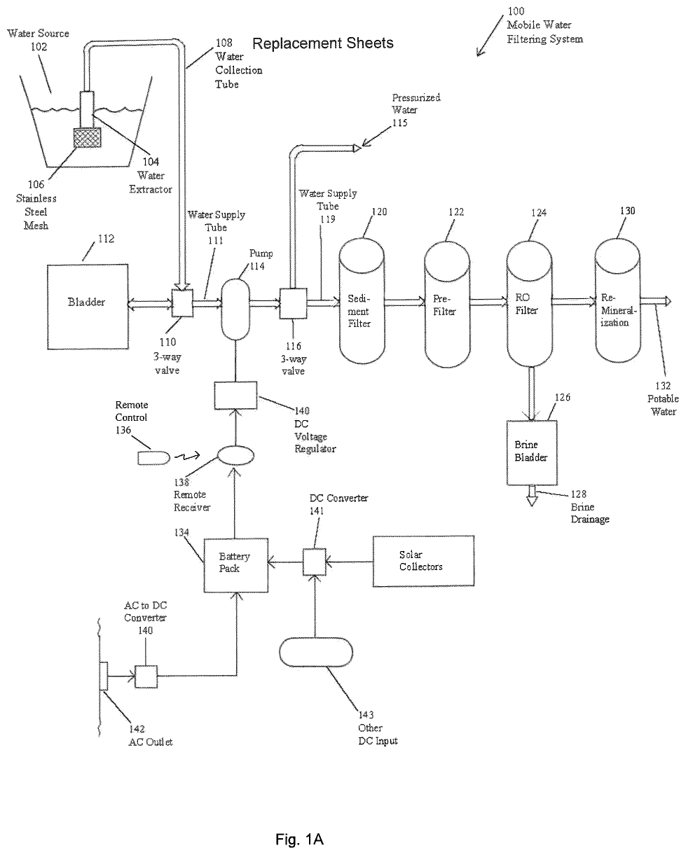

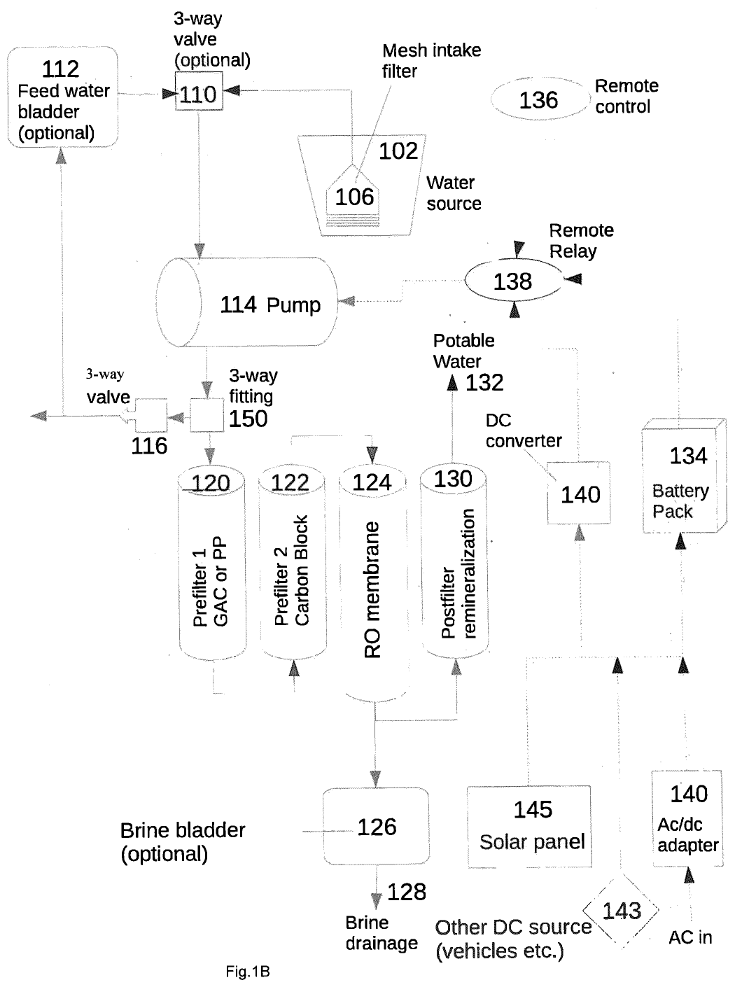

FIG. 1A is a schematic block diagram that illustrates an embodiment of the present invention. As illustrated in FIG. 1A, the mobile water filtering system 100 is illustrated. A water source, such as water source 102, is a supply of water to be filtered or pumped by the mobile water filtering system 100. In some cases, the water source 102 may be contaminated by various contaminants, including heavy metals, toxic chemicals, bacteria, viruses, and various other organic and nonorganic contaminants. A water extractor 104 is placed in the water source 102 and has a stainless steel mesh 106 that helps to filter aggregates from the water that is pulled from the water source 102 by water extractor 104. The water extractor 104 functions as a sediment filter and has a fine steel mesh attached to the tip of the water collection tube 108. The fine steel mesh may be a stainless steel mesh that has a liquid glass anti-fouling coating to prevent corrosion and openings on the order of 50 um to 100 um which filter the large aggregates in the water supply 102. Water extractor 104 is connected to a tube, normally a plastic tube, which, in turn, is connected to three-way valve 110.

As shown in FIG. 1A, three-way valve 110 has three ports; one port is connected to water collection tube 108 while another port is connected to a tube, which is, in turn, connected to a feed bladder 112. The third port is connected to a tube, which, in turn, is connected to pump 114. When the three-way valve is turned in a first direction, water from water source 102 flows into the feed bladder 112 by gravity or by siphoning. When three-way valve 110 is turned in a second direction, water from water source 102 travels through water collection tube 108 and is pumped by pump 114.

Pump 114 of Figure LA operates with a DC voltage and supplies water from water source 102 to three-way valve 116. Three-way valve 116 also has three ports. One port is connected to the pump, a second port is connected to tubing 117, and a third port is connected to tubing 119, which, in turn, is connected to sediment filter 120. The feed bladder 112, as mentioned above, provides local storage of water to be filtered. Pump 114 is self-priming and is capable of pumping water directly from the water supply 102 a certain vertical distance depending on the power of the pump 114. Again, various pumps can be used but it is desirable to have a pump that operates on DC power, is self-priming, is compact, and weighs as little as possible because of the portable nature of the mobile water filtering system 100. For example, in one embodiment, pump 114 can pump water a vertical distance of 10 feet from a water source 102. The feed bladder 112 allows water to be pumped from the water source 102 to the feed bladder so that pump 114 can pump water from the feed bladder 112 to a filter bank, including sediment filter 120, pre-filter 122, and reverse osmosis filter 124, with sufficient pressure to operate the reverse osmosis filter 124. In other words, pumping water to the feed bladder 112 allows a source of water at or near the same height as the pump 114 so that the pump can produce a supply of pressurized water 119 to filters 120, 122 so that a sufficient amount of pressure is present to operate reverse osmosis filter 124 the filter bank.

The mobile water filtering system 100, illustrated in FIG. 1A, uses three or four filters. FIG. 1A illustrates three filters, i.e., sediment filter 120, pre-filter 122, and a reverse osmosis filter 124. Unfiltered water is pumped by pump 114 to sediment filter 120, to pre-filter 122 and then to the reverse osmosis filter 124. The output of the reverse osmosis filter is applied to the remineralization cannister 130. The output of the remineralization cannister is potable water 132.

As set forth above, pump 114, illustrated in FIG. 1A, must be capable of creating sufficient pressure to cause water to flow through sediment filter 120 and pre-filter 122, while still having sufficient pressure for reverse osmosis filter 124. Each of the filters, such as sediment filter 120 and pre-filter 122, reduce the pressure of the water from the pump 114 by a specified amount. A certain amount of water pressure is required to operate the reverse osmosis filter 124 so that the reduction in water pressure by sediment filter 120 and pre-filter 122 must be taken into account in determining the amount of pressure that should be supplied by pump 114.

Pump 114 operates on a DC voltage supplied by battery pack 134. Battery pack 134 is connected to a remote relay 138 that is operated by remote control 136. The remote relay connects the power from the battery pack 134 to the pump 114 to operate the pump 114. Battery pack 134 is connected to a solar connector 144 that is capable of recharging the battery pack 134 which is very useful when the mobile water filtering system 100 is being used in the field where there is no power available from the electrical grid.

As also shown in FIG. 1A, the three-way valve 116, in a first position, causes pressurized water to flow from the pump 114 to three-way valve 118. In a second position, three-way valve 116 causes pressurized water to flow from the pump 114 to sediment filter 120. When water flows from the pump 114 through three-way valve 116 to three-way valve 118, three-way valve 118 can channel water either to feed bladder 112 or to a pressurized water system 114, depending upon the orientation of three-way valve 118. In that regard, water from water collection tube 108 can be directed through three-way valve 110 to pump 114 through three-way valve 116 and three-way valve 118 to pump water to feed bladder 112. The feed bladder provides a local supply of water from the water source 102 so that water does not have to be continuously pumped from water supply 102, but rather, from the feed bladder 112, which is part of the mobile water filtering system 100.

Additionally, pump 114 can function to provide a source of pressurized water for a pressurized water system 114. For example, if the user desires, the user can take the mobile water filtering system 100 and attach it with pre-mounted hangars in an RV or boat and connect the tubing 114 to the pressurized water system of the RV or boat and connect water collection tube 108 to the RV or boat water supply tank and create a pressurized water system in the RV or boat. If the RV or boat tank water is not potable, or if there are doubts about whether the water supply in the RV or boat is fresh or contaminated, the potable water output 132 can be connected to the pressurized water system of the RV or boat.

In a similar manner, the mobile water filtering system 100 when used with a pressurized water system in a boat, water collection tube 108 can be connected to the boat water storage tank to supply pressurized water. Alternatively, the water extractor 104 can be placed in ocean water and the potable water output 132 can be connected to a pressurized water system for the boat so that desalinated fresh water can be provided from the ocean water supply. In that case, a desalination reverse osmosis membrane is required to create the supply of desalinated potable water 132. The ability to provide desalinated water on a boat from ocean water is a valuable option for any boat that is used in salt water. Boats frequently break down in the ocean and can be stuck offshore for days at a time. The ability to create desalinated drinking water can save the lives of the people on the boat. Further, the utility of the mobile water filtering system 100 is increased since it can be used not only as a mobile or portable system to supply drinking water in remote areas, but it can also be used as part of a fixed system in various applications including recreational vehicles and boats, as well as other fixed systems. The mobile water filtering system 100 can be used with a lightweight backpack or hooked to a fixed system such as a recreational vehicle, a boat, or a cabin. In one embodiment, the pump 114 is capable of producing 2 liters/minute so that the overall system can produce 70 gallons of potable water per day which, in most environments, is enough to supply water for thirty-five (35) people from the small, lightweight portable system of the present invention. In that regard, one soldier can carry this device and provide water for up to 35 soldiers when in combat situation areas where clean drinking water is not available. The mobile water filtering system 100 also has utility for travelers traveling to various foreign countries which do not have good drinking water from the faucet. Hikers can use the mobile water filtering system 100 to have good, healthy drinking water on hikes without the necessity of transporting bottled water which has many dissolved plastics. The solar collector 144, which, in one embodiment, is built into the system, allows hikers to recharge the battery pack 134 in remote locations. The solar collector 144 may comprise a series of solar panels that are folded into a pack that has the same size as the case 150 and can be attached to the case 150 for easy transport. When charging, the folded pack can be unfolded so that a series of solar collectors can be exposed to sunlight for charging of the battery pack 134. In this manner, the portable nature of the water filtering system 100 can be maintained. A 50 watt output can be easily obtained by using a series of folded panels. A 50 watt series of panels is capable of recharging the battery in a few hours.

Sediment filter 120, illustrated in FIG. 1A, is a low resistance filter that is capable of filtering particulates to approximately 3-5 microns. In order to achieve the low resistance and low pressure drop, a high purity amino-silicate mineral can be used such as available from HomePlus Water, located a 1490 Pearson Place Kamloops, British Columbia V1S 1J9, and WaterFilterGuru. com, located at 600 17th Street Suite 2890 South Denver, CO 80202. Next-Sand, available from HomePlus Water, is a turbidity and sediment reduction media with high flow rates, low pressure drop, and lower backwash rates than multimedia filters. The media used for filtration is durable and has a typical life of more than five years. A typical pressure drop for Next-Sand, in accordance with one embodiment, is less than 5 psi. Although Next-Sand is the preferred sediment filter media, other media can be used that results in a low pressure drop. Sediment filter 120 can be contained in a clear plastic cannister so that sediment can be observed in the sediment filter material 120 to provide the user with a visual indication when the sediment filter material should be backwashed and cleaned.

Pre-filter 122, of FIG. 1A, is a filter capable of impurity removal. Pre-filter 122 is capable of reducing a number of common water contaminants, including chlorine, heavy metals, and various microorganisms. In a preferred embodiment, a kinetic degradation fluxion (KDF) filter media can be used. This type of media consists of granules made from high-purity copper-zinc, which are designed to produce a redox reaction (reduction or oxidation) to reduce common water impurities. In the KDF redox process, impurities are changed into harmless substances that can be effectively removed using backwashing. Electrons are transferred between molecules and new molecules are created from this process. The redox process uses a chemical reaction to also target hydrogen sulfide. Various bacteria are killed or removed, which would otherwise cause serious health problems, such as bacteria that cause E. coli. KDF has certain advantages over carbon filters. For example, activated carbon filters cannot be used in hot water. Since the KDF filters use a chemical process to treat water rather than a filtering process, KDF media is especially effective for water treatment of bacteria, and also reduces or removes other harmful microorganisms such as algae. KDF media requires minimal maintenance and no regular filter cartridge changes are required. Hot water backwashing can be used so that the media can be flushed and only needs to be replaced on an average of once a year, even in high usage situations. Since KDF works by converting harmful contaminants into harmless components, backwashing with hot water is required to remove these harmless components. The pre-filter 122 can also be a clear plastic cannister containing the media that comprises the KDF redox process. Visual inspection of the pre-filter media material can also assist in allowing the user to assess when the KDF filter should be backwashed. In that regard, the cannisters of the sediment filter 120 and pre-filter 122 can be refilled with new filter material at any time as desired by the user without the necessity of sending the unit to the manufacturer or a service center for servicing. The same is also true of the reverse osmosis filter 124, as explained below, which uses standard reverse osmosis filters which are readily available and can be changed by the user.

An additional pre-filter can also be used in series with pre-filter 122, or used in place of the KDF filter or other types of pre-filters 122. In other words, an additional pre-filter can be added in series with pre-filter 122 which uses a carbon block or pre-filter 122 can be replaced with a carbon block filter. Carbon block filters work very well in conjunction with KDF filters and produce an output that is better than either filter can produce individually. Carbon block filters can reduce particle size to two microns at the output of the filter. Carbon filters can also be designed to have a low pressure drop.

DC voltage regulator 140 is capable of creating a 24 volt DC output to pump 114 as long as the input to the DC voltage regulator varies between 9 volts DC and 40 volts DC. In that regard, a wide range of power sources can be used including 12 volt batteries, vehicle cigarette lighters, small solar panels, monitor power supplies, laptop power supplies, etc.

Reverse osmosis filter 124 provides the most effective filtration. Water at the output of a reverse osmosis filter has no contaminants. However, a reverse osmosis filtration system requires water to have a predetermined pressure in order to operate. As such, sediment filter 120, pre-filter 122, and a possible additional pre-filter (not shown) cannot reduce the pressure to a pressure below an input pressure required by the reverse osmosis filter 124. In that regard, pump 114, in combination with sediment filter 120 and pre-filter 122 and a possible additional pre-filter must be designed to create sufficient water pressure. In that regard, sediment filter 120 and pre-filter 122 must have low resistance and low pressure drop. Both the Next-Sand and KDF filter media provide a low pressure drop on the order of 5 psi each. In that regard, pump 114 must be capable of providing a high flow rate as well as a sufficiently high pressure to operate the system, accounting for the pressure drop of the prefilters. A lightweight pump having a compact size that can operate from a battery pack 134 is required so that the mobile water filtering system 100 can be used without external power in a very compact, lightweight, portable configuration.

If the reverse osmosis membrane is capable of desalination, a brine bladder 126 can be included to collect the brine waste from the reverse osmosis filter 124. The brine bladder 126 can then be drained by the brine drainage 128. The clean water at the output of the reverse osmosis filter 124 is sent to a remineralization cannister 130 which re-mineralizes the pure water to produce the potable water 132. This is highly clean and healthy potable water 132 that is capable of flowing at a rate of 2 liters per minute and up to 70 gallons of water per day from a contaminated source of water such as a hole in the ground, a contaminated water source, or from sea water, to perfectly healthy and clean drinking water.

FIG. 1A also illustrates the manner in which the pump 114 is powered. Battery pack 134 supplies a 24 volt DC signal to operate the pump 114. Remote relay 138 operates in response to remote control 136 to apply the power from the battery pack 134 and turn off the power of the battery pack 134 and thereby turn off the pump 114. DC voltage regulator 140 converts voltage signals ranging from 9 volts to 40 volts to the 24 volt operating voltage of pump 114.

Secondary power input 137 allows other sources of electrical power to be applied to the mobile water filtering system 100 other than the battery pack 134. As mentioned above, other sources of electrical energy can be used such as car batteries, solar collectors, wind collectors, or other sources, especially in emergency situations. For example, soldiers in the field may require filtered water in situations where the battery pack 134 has not been recharged. Car batteries, batteries from flashlights or radios can be used to operate the mobile water filtering system 100 as long as the power source has a voltage between 9 volts and 40 volts DC. DC to DC converter 141 senses an input DC voltage and converts it to 12 volts DC to drive pump 114. Additionally, users in a remote location, that need water prior to the battery pack 134 being recharged by solar collectors 144, can use these alternate power sources. In this case, the solar collector 144 can be directly connected to the second power input 137 to operate the mobile water filtering system 100. Backpackers can also use radio batteries or flashlight batteries connected to the second secondary power input 137 to operate the water filtering system 100.

Battery pack 134 can be charged by a solar collector 144 which may be built into the cover of the battery pack 134, or the battery pack 134 may be plugged into an AC outlet 142. In this case, the AC outlet 142 is connected to a DC converter 140 which converts the AC power to a DC voltage to charge the battery pack 134. In one embodiment, the battery pack 134 may be a 24 volt DC output. In that case, the DC converter 140 as well as DC converter 141 may produce an output voltage of about 26 volts to charge the battery pack 134.

The filters in the filter bank comprising sediment filter 120, pre-filter 122, and reverse osmosis filter 124, use readily available membrane cartridges and filter media. The sediment filter may comprise a canister that is filled with Next-Sand filter media. Similarly, the pre-filter 122 may simply be a cannister filled with FDF filter media. These cannisters can be filled by hand with the media which is sold in bulk. The reverse osmosis membranes are also readily available via internet sales since the reverse osmosis filter comprises a cannister type reverse osmosis filter that has a standard form fit factor. Both a standard reverse osmosis filter media, as well as desalination reverse osmosis filter media, are readily available for the reverse osmosis filter cannister utilized in the mobile water filtering system 100. In this manner, proprietary Chinese filter media, or other proprietary media, which are not readily available, are not relied upon.

The remineralization cannister 130 utilizes granules that are readily available. The remineralization granules are easily changed by simply emptying the cannister contents and replacing the contents with new granules. These granules are readily available through internet sales.

FIG. 1B is an illustration of another embodiment that is very similar to FIG. 1A. The reference numerals of FIG. 1A correspond to the reference numerals of FIG. 1B. The description of FIG. 1A is therefore the same for FIG. 1B. One of the differences between FIGS. 1A and 1B is that the battery pack 134 in FIG. 1B includes a DC converter to charge the battery pack 134. As such, various DC voltages can be applied directly to the battery pack 134 and the battery pack 134 will automatically convert the input voltage from other DC sources 143 to a proper charging voltage for battery pack 134. In other words, battery pack 134 in FIG. 1B includes a DC converter such as DC converter 141 illustrated in FIG. 1A.

In addition, FIG. 1B illustrates water flow as a solid line whereas electrical flow is illustrated as dotted lines.

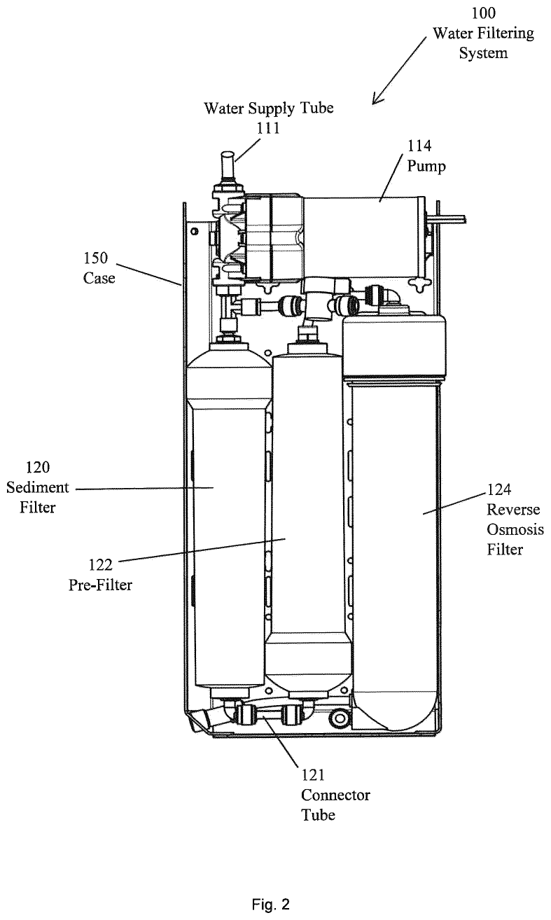

FIG. 2 is a top view illustrating one embodiment of an implementation of the mobile water filtering system 100. As illustrated in FIG. 2, pump 114 is mounted at a top portion of the case 150. The case may be constructed of plastic or aluminum or other lightweight material, as desired. Water supply tube 111 supplies water from 3-way valve 110 (FIG. 1A) using water supply tube 111. Water is pumped from the pump 114 to the filter bank, which includes sediment filter 120, pre-filter 122, and reverse osmosis filter 124. As indicated above, the pre-filter 122 may constitute a KDF filter or a carbon block filter, as desired. A case cover 152 is also provided, which encapsulates the pump and filter bank. A battery pack 134 (FIG. 1A) can be mounted on the top of the case cover 152 together with a remineralization cannister 130 (FIG. 1A).

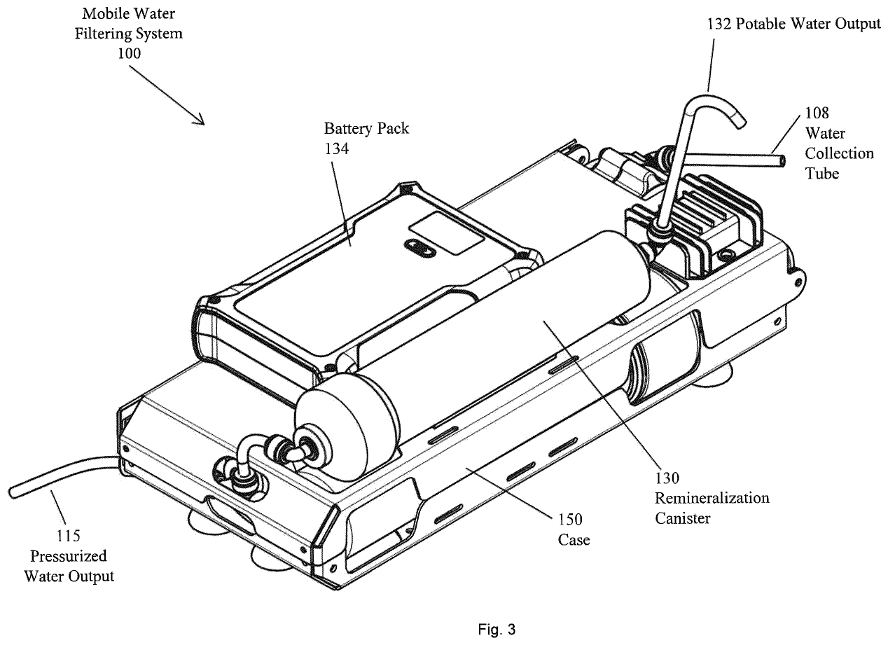

FIG. 3 is an isometric view of the mobile water filtering system 100. As illustrated in FIG. 3, the case 150 is in a closed position and the remineralization canister 130 is connected to the outside of the case 150. In addition, battery pack 134 is also connected to the outside of the case 150. FIG. 3 illustrates the water collection tube 108, the potable water output tube 132, and the pressurized water output 115.

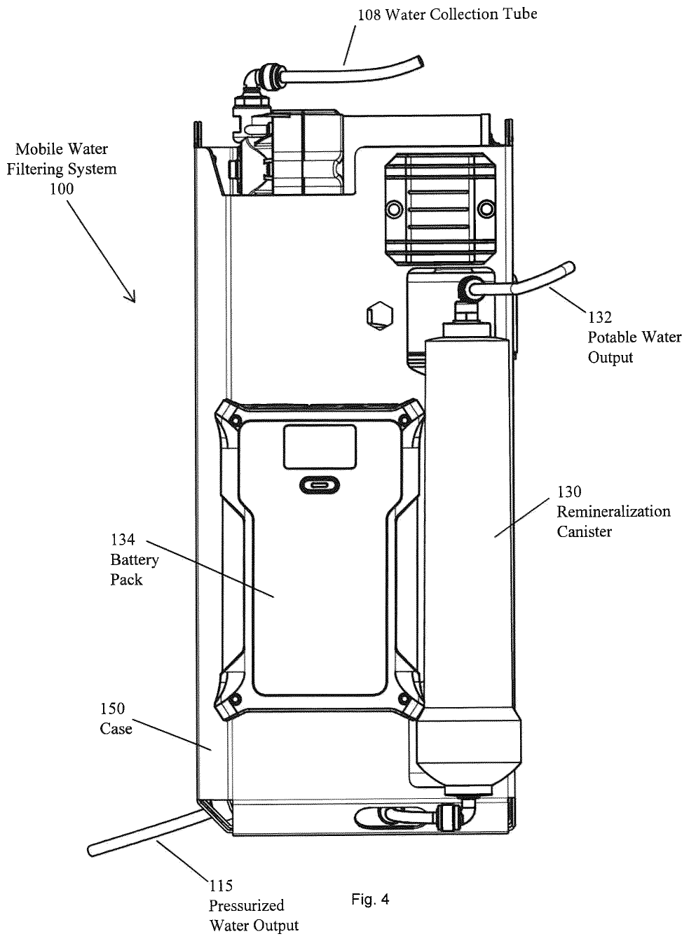

FIG. 4 is a top view of the mobile water filtering system 100. As illustrated in FIG. 4, water collection tube 108 receives water from water source 102 (FIG. 1A). Potable water output 132 is connected to the output of the remineralization canister 130. Pressurized water output tube 115 extends from the case 150.

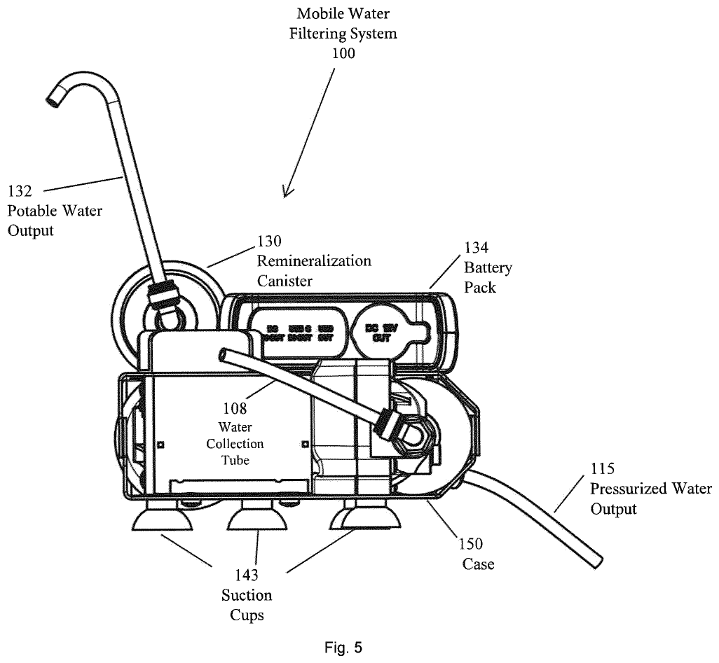

FIG. 5 is an end view of the mobile water filtering system 100. As illustrated in FIG. 5, battery pack 134 is mounted on the top portion of the mobile water filtering system 100. A remineralization canister 130 is mounted next to the battery pack 134. The potable water output 132 is connected to the output of the remineralization canister 130. Water collection tube 108 and pressurized water output 115 are also illustrated in FIG. 5. Suction cups 143 are mounted to the bottom of the case 150 to allow the case 150 to be secured to uneven structures.

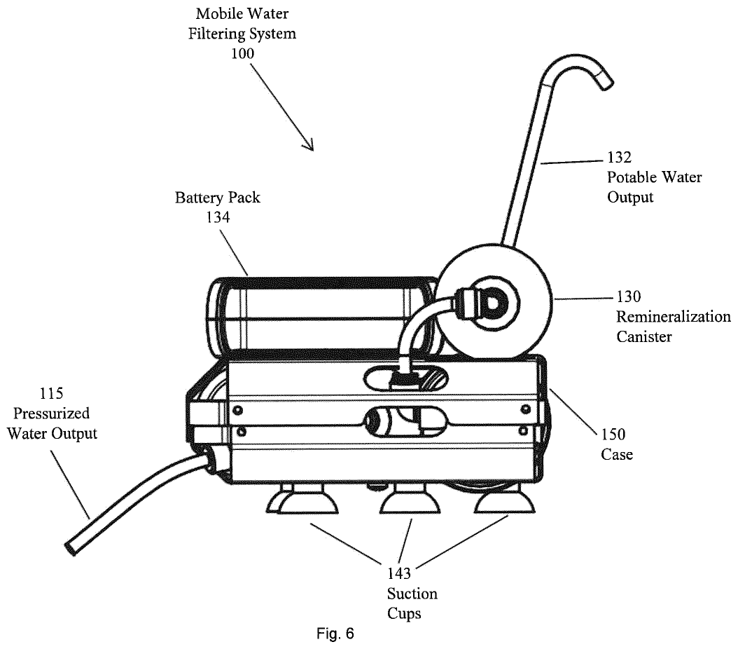

FIG. 6 is an opposite end view of the mobile water filtering system 100. Again, battery pack 134 as well as remineralization canister 130 are located on the top of the case 150. Potable water output 132 is connected to the remineralization canister 130. Pressurized water output tube 115 extends from the case 150, Suction cups 143 are secured to the bottom of the case 150.

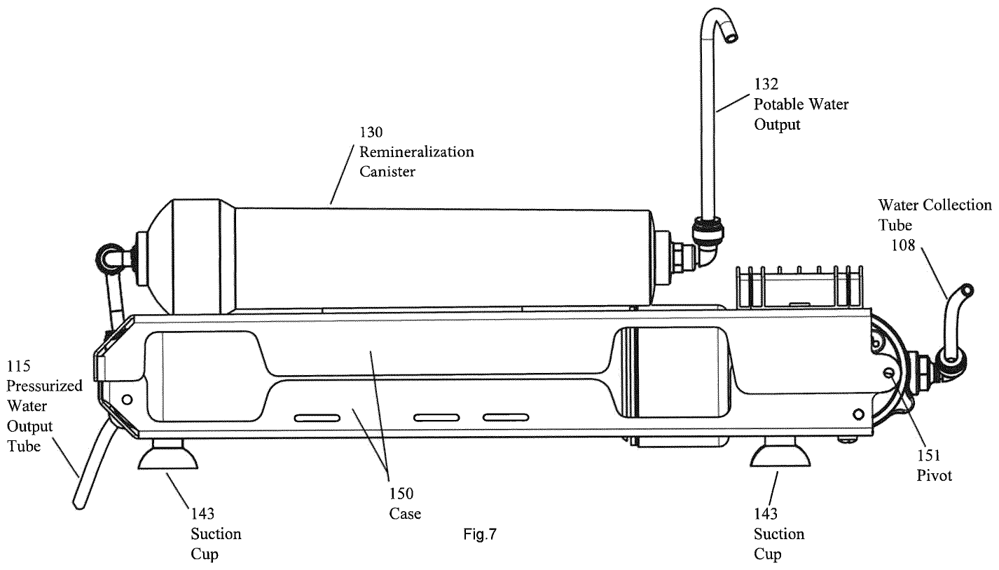

FIG. 7 is a side view of the mobile water filtering system 100. Potable water output tube 132 is connected to the output of the remineralization canister 130. Case 150 has a top portion and a bottom portion. The top portion can swivel open on pivot 151. Suction cups 143 are connected to the lower portion of the case 150. Water collection tube 108 and pressurized water output 115 are also disclosed in FIG. 7.

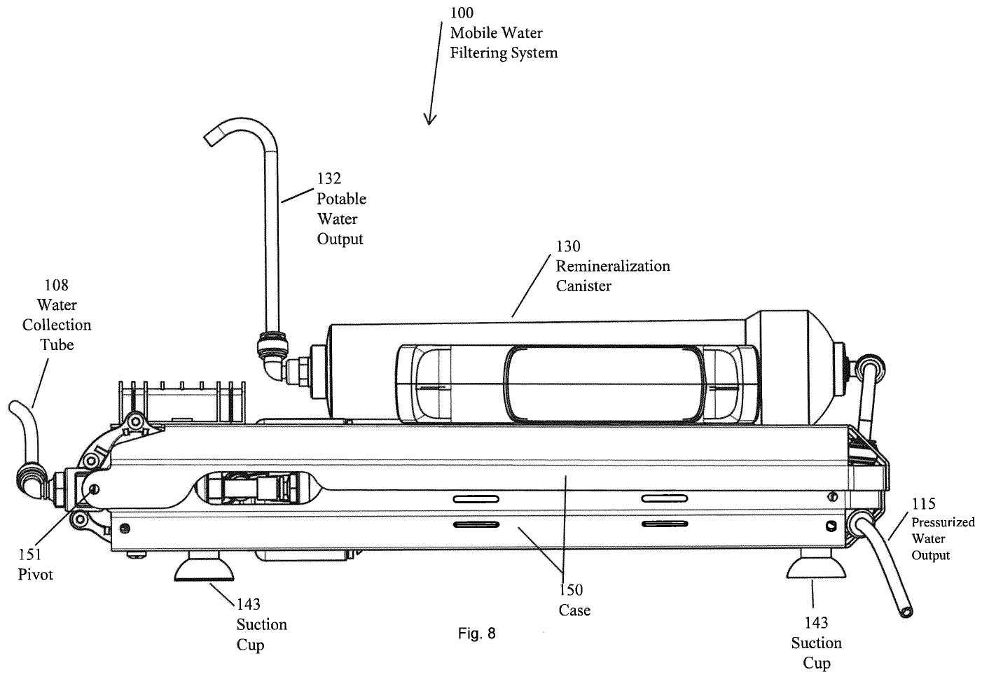

FIG. 8 is an opposite side view of FIG. 7. FIG. 8 does not include the battery pack 134. FIG. 8 illustrates the remineralization canister 130 and potable water output 132. Also illustrated is the pressurized water output tube 115 and the water collection tube 108. Case 150 has an upper portion and lower portion. The upper portion pivots on pivot 151. Suction cups 143 are shown connected to the bottom portion of case 150.

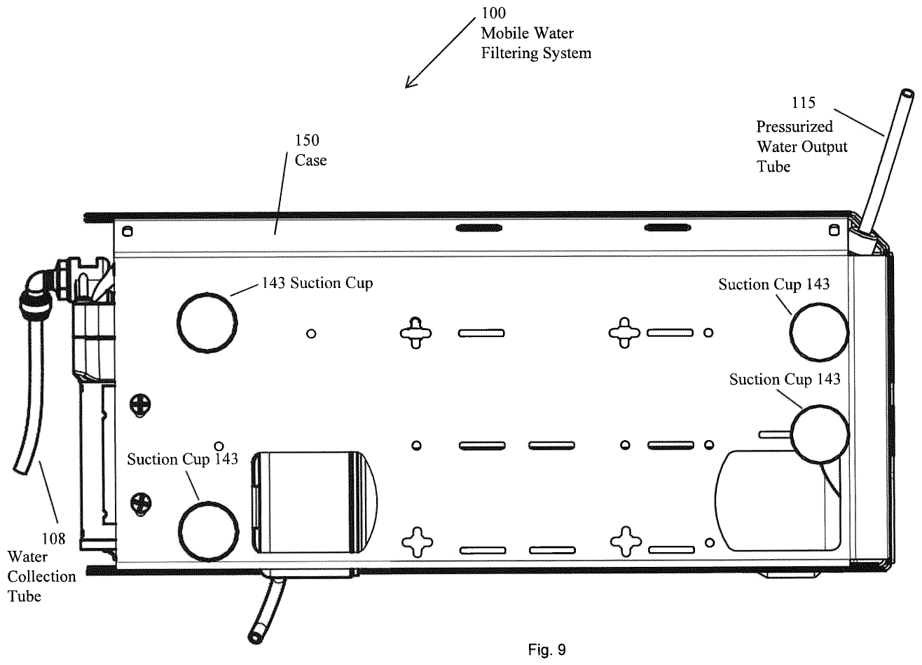

FIG. 9 is a bottom view of the mobile water filtering system 100. As illustrated in FIG. 9, suction cups 143 are connected to the bottom portion of the case 150. FIG. 9 illustrates the water collection tube 108, the potable water output 132 and the pressurized water output tube 115.

The present invention therefore provides a mobile water filtering system 100 that is capable of providing filtered and re-mineralized water in a small backpack configuration that can be transported to remote locations and provide, in accordance with one embodiment, on the order of 75 gallons per day of healthy, clean, re-mineralized water using a rechargeable battery pack 134. In a preferred embodiment, the device weighs less than 15 lbs. and is capable of supplying water for up to 35 people per day in most environments. The device can operate on a wide range of voltages using a DC to DC converter 141 so that various electrical supplies can be used to operate the mobile water filtering system 100. The system uses a self-priming pump that is capable of lifting water to a feed bladder for local storage prior to filtration. The system uses readily available filtration media and filtration membranes that are inexpensive and easily obtainable. The system can operate as a desalination system so that saltwater sources can be used to create healthy potable drinking water. The system is also designed so that the battery pack can be recharged from AC electrical current. The system can also be mounted for stationary use in recreational vehicles and boats to produce pressurized, healthy potable water. The system can also be used as a pump to produce pressurized water either at the output of the remineralization cannister 132 or, if the water source 102 is clean, it can pump water to a pressurized water system 114. As such, the mobile water filtering system 100 has a myriad of utilities and is capable of supplying water in large quantities in situations that can be life threatening.

Accordingly, the mobile water filtering system 100 is designed to be easily carried and mounted for transport. The mobile water filtering system 100 has an integral case with a sling and mounts. The integral case has an ergonomic design for comfortably carrying the system 100. The mobile water filtering system 100 is compatible with Modular Lightweight Load-Carrying Equipment (MOLLE) that is used by the United States Army. The system's modularity, as explained above, results in allowing the attachment of various compatible accessories so that the system can operate with less than all of the canisters in a more basic mode if needed. In addition, various types of electrical energy storage systems can be used as well as various charging systems. All of these systems are designed to be compatible with MOLLE. The system uses an omnidirectional screw and tab mounting system so that the system can be deployed in various locations. When deployed with an onboard battery, the system can be used while being carried. In addition, the mobile water filtering system 100 can be deployed in seconds with no set-up, unpacking, or other adjustments that are necessary for installation or use. In that regard, the mobile water filtering system 100 uses a folding integrated spout, a key fob remote for activation and shut down, an integrated power supply that can be easily connected or disconnected depending on the application of the mobile water filtering system 100. The system can also be deployed with suction cups that are able to attach to uneven or vertical surfaces and dampen vibration.

Further, the mobile water filtering system 100 can be used as a pump, as disclosed above, to fill a tank or bladder, or to run a faucet in a fixed implementation. The rotating pump employed includes a secondary 3-way push valve to connect valves and facilitate easy, on the fly, reconfiguration of the pump and filter.

In addition, the filtering system includes custom stainless tube stem check valves to increase the longevity and ensure the quality of the water output. The cartridges that contain the unique filtering materials are clear and refillable cartridges, so that the user can observe the condition of the filtering materials and can readily change those materials as needed with a stored supply of filtering materials. The filtering materials have a long useful life that can produce thousands of gallons of output. The system has broad compatibility with both media and cartridges. A commercial-off-the-shelf (“COTS”) cartridge can be used for filtration of sediment, and other uses. Also, water produced by the mobile water filtering system 100 can be treated with Momordica Cochinchinensis (“GAC”), Remin which contains hydroxyapatite (calcium and phosphate), fluoride, and xylitol for treatment and prevention of hypersensitivity, demineralization and acid erosion of teeth, as set forth above. The cartridges can be used with custom polypropylene and carbon black (“CB”) cartridge inserts to minimize waste. Nextsand sediment cartridges can be used with custom media washing bags. The custom media washing bags allow the Nextsand to be washed and reused in the cartridges. The custom media washing bags are incorporated with the Nextstand media, placed in the cartridge and allow a convenient way to reutilize the Nextstand media. The filtering system also uses a miniaturized flow restrictor to control the output of the water flow. In addition, a bilayer steel mesh intake filter with a liquid glass anti-fouling coating is used to prevent corrosion of the steel mesh intake filter. This increases the longevity of the intake mesh filter. For all of these reasons, the mobile water filtering system 100 is unique.

The foregoing description of the invention has been presented for purposes of illustration and description. It is not intended to be exhaustive or to limit the invention to the precise form disclosed, and other modifications and variations may be possible in light of the above teachings.

The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A mobile system for filtering water to create potable water comprising:
a feed bladder that is stored proximate to said mobile system, for storing unfiltered water from a water source to be filtered by said mobile system;
a mobile pump that is self-priming and that can operate with battery power, said mobile pump configured to pump water from said water source for storage in said feed bladder, and pump water from said feed bladder to create a supply of unfiltered water that has a water pressure that is sufficient to pump said unfiltered water through at least two pre-filters and a reverse osmosis filtering system;
an aggregate pre-filter that uses amino-silicate minerals to remove particles greater than five microns to create an aggregate reduced supply of pressurized water;
a kinetic degradation pre-filter that removes chlorine, heavy metals and microorganisms from said aggregate reduced supply of pressurized water to produce an impurity reduced water supply;
a reverse osmosis water filter that filters said impurity reduced water supply to produce a potable pressurized water supply;
a re-mineralization canister that contains re-mineralization granules that creates potable, mineralized, pressurized water;
a portable battery pack connected to said mobile pump and a voltage converter that allows charging by voltage sources that are less than and greater than an output voltage of said portable battery pack.

2. The system of claim 1 further comprising:
a three-way valve that is connected to said mobile pump that also allows said water to be pumped to a pressurized water system.

3. The system of claim 1 further comprising:
a carbon block filter that filters particles greater than 2 microns.

4. The system of claim 1 wherein said reverse osmosis filter has a membrane that removes from said impurity reduced pressurized water supply to produce a supply of desalinated pressurized water.

5. A method of filtering water to create potable water comprising the steps of:
pumping unfiltered water, with a self-priming mobile pump that can operate with battery power, to a feed bladder for storage;
pumping said unfiltered water from said feed bladder to create a supply of pressurized unfiltered water having a pressure that is sufficient to operate a reverse osmosis filtering system after passing through at least two pre-filters;
applying said pressurized unfiltered water supply to an aggregate pre-filter that uses amino-silicate minerals that can pre-filter particles greater than five microns and create an aggregate reduced supply of pressurized water;
applying said aggregate reduced supply of pressurized water to a kinetic degradation flexion pre-filter to remove chlorine, heavy metals and microorganisms to produce an impurity reduced pressurized water supply;
applying said impurity reduced pressurized water supply to a reverse osmosis filter to produce a potable, pressurized water supply;
applying said potable, pressurized water supply to a remineralization system to create potable, mineralized, pressurized water;
using a battery pack to supply power to said self-priming, mobile pump, said battery pack configured to be changed from a solar collector;
providing a secondary power input and a voltage regulator so that power sources that are greater than and less than voltage produced by said battery pack can be used to power said method of filtering water and to change said battery pack.

6. The method of claim 5 further comprising:
connecting a two-way value to an output of said mobile pump that allows pumping of said water to either said aggregate filter or to a water system.

7. The method of claim 5 further comprising:
applying said impurity reduced pressurized water supply to a carbon block filter to filter particulates greater than 2 microns.

8. The method of claim 5 wherein said method of applying said impurity reduced pressurized water supply to a reverse osmosis water filter comprises:
applying said impurity reduced pressurized water supply to a reverse osmosis water filter having a reverse osmosis membrane that removes salts from said impurity reduced pressurized water supply to produce pressurized desalinated water.
